(19) United States
(12) Patent Application Publication
(10) Pub. No.: US 2002/0044654 A1
(43) Pub. Date: Apr. 18, 2002

(54) DATA TRANSMITTING APPARATUS AND DATA TRANSMITTING METHOD

(76) Inventors: YASUAKI MAEDA, KANAGAWA (JP); KAZUHIKO FUJIIE, KANAGAWA (JP)

Correspondence Address: OBLON SPIVAK MCCLELLAND MAIER NEUSTADT PC, 1755 Jefferson Davis Highway, Fourth FL, Arlington, VA, 22202, US

(21) Appl. No.: 09/129,613

(22) Filed: Aug. 5, 1998

(30) Foreign Application Priority Data
Aug. 13, 1997 (JP) P09-218623

(51) Int. Cl. H04L 9/00

(52) U.S. Cl. 380/43

(57) ABSTRACT

The present invention is a data transmitting apparatus and a method thereof. According to the present invention, with a compatibility to a conventional digital audio interface, a digital audio signal is bidirectionally transmitted. By encrypting data to be transmitted, the security of digital audio data can be improved.

### BACKGROUND OF THE INVENTION

1. Field of the Invention

The present invention relates to a data transmitting apparatus for transmitting digital audio data between digital audio units and a method thereof.

2. Description of the Related Art

Digital audio units have been widely used as a CD player (that reproduces a digital audio signal from a Compact Disc (registered trademark) as an optical disc), an MD recorder/player (that records and reproduces a compressed digital audio signal from a Mini Disc (registered trademark) as an optical disc or an magneto-optical disc), a digital audio tape recorder (DAT) (that records/reproduces a digital audio signal to/from a magnetic tape with rotating heads), and so forth.

In addition, as communication networks are becoming common, a service for circulating various types of music data to user terminals through an ISDN (Integrated Services Digital Network) circuit and/or a communication satellite will be provided in near future.

As digital audio units are widely used and computer communication networks become common, a digital interface that transmits digital audio data between audio units becomes important.

So far, a digital audio interface corresponding to the IEC (International Electro-technical Commission) 958 standard (hereinafter, this interface may be referred to as IEC 958 digital audio interface) has been widely used so as to connect digital audio units.

The IEC 958 digital audio interface unidirectionally transmits PCM (Pulse Code Modulation) data.

Thus, with the IEC 958 digital audio interface, a bidirectional communication of which audio data is encrypted for certification and confirmation cannot be performed. Consequently, with the IEC 958 digital audio interface, digital audio data cannot be sufficiently protected from being illegally accessed or copied.

To solve such a problem, it is possible to develop a new digital audio interface.

However, digital units with connectors suitable for optical transmission corresponding to the IEC 958 standard have become common. In other words, it is necessary to maintain the compatibility with the IEC 958 digital audio interface.

As another method to solve such a problem, using two sets of interfaces, a data communication can be bidirectionally performed. In this case, however, the operation will become complicated. In addition, since two cables are required, the cost will increase.

### OBJECTS AND SUMMARY OF THE INVENTION

Therefore, an object of the present invention is to provide a data transmitting apparatus and a data transmitting method that have a compatibility with conventional digital audio interfaces and that protect data from being illegally accessed or copied.

The present invention is a data transmitting apparatus having a first digital unit and a second digital unit, a connector of the first digital unit and a connector of the second digital unit being connected with a cable, wherein the first digital unit has a bidirectional interface means for transmitting/receiving data through the cable, an encoding means for encoding a message transmitted from the first digital unit to the second digital unit into a predetermined data sequence, a decoding means for decoding a data sequence received through the bidirectional interface means into a message transmitted from the second digital unit to the first digital unit, and an encrypting means for encrypting a digital signal transmitted from the first digital unit to the second digital unit, wherein the second digital unit has a bidirectional interface means for transmitting/receiving data through the cable, an encoding means for encoding a message transmitted from the second digital unit to the first digital unit into a predetermined data sequence, a decoding means for decoding a data sequence received through the bidirectional interface means into a message transmitted from the first digital unit to the second digital unit, and a decrypting means for decrypting an encrypted digital signal received from the first digital unit, and wherein when a digital signal is transmitted from the first digital unit to the second digital unit, a message including encryption information is bidirectionally exchanged between the first digital unit and the second digital unit.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a perspective view showing an example of an optical interface according to the present invention;

FIG. 2 is a sectional view showing the optical interface shown in FIG. 1;

FIG. 3 is a sectional view showing another example of an optical interface according to the present invention;

FIG. 4 is a schematic diagram showing an example of an interface composed of a conventional coaxial cable;

FIG. 5 is a schematic diagram showing connections of an example of an interface composed of a bidirectional coaxial cable according to the present invention;

FIGS. 6A and 6B are block diagrams showing an example of the structure of a data transmitting apparatus according to the present invention;

FIG. 7 is a schematic diagram showing an example of a data format of the data transmitting apparatus according to the present invention;

FIG. 8 is a schematic diagram showing an example of a data transmission format of the data transmitting apparatus according to the present invention;

FIG. 9 is a schematic diagram showing an example of the data transmission format of the data transmitting apparatus according to the present invention;

FIG. 10 is a table showing an example of the data transmission format of the data transmitting apparatus according to the present invention;

FIG. 11 is a schematic diagram showing an example of the data transmission format of the data transmitting apparatus according to the present invention;

FIG. 12A is a timing chart for explaining a data transmitting process of the data transmitting apparatus according to the present invention;

FIG. 12B is a timing chart for explaining the data transmitting process of the data transmitting apparatus according to the present invention;

FIG. 13A is a timing chart for explaining the data transmitting process of the data transmitting apparatus according to the present invention;

FIG. 13B is a timing chart for explaining the data transmitting process of the data transmitting apparatus according to the present invention;

FIG. 14A is a timing chart for explaining the data transmitting process of the data transmitting apparatus according to the present invention;

FIG. 14B is a timing chart for explaining the data transmitting process of the data transmitting apparatus according to the present invention;

FIG. 15 is a schematic diagram for explaining a data circulating system; and

FIG. 16 is a perspective view for explaining a modification of the present invention.

### DETAILED DESCRIPTION OF THE PREFERRED EMBODIMENTS

Next, with reference to the accompanying drawings, an embodiment of the present invention will be described. In a digital audio system according to the present invention, an optical cable corresponding to the IEC 958 standard is used.

With the optical cable, data can be bidirectionally transmitted. Since data is bidirectionally transmitted, an encrypting process can be performed in the following manner. For example, a first unit transmits a public key to a second unit. The second unit transmits a common key encrypted with the public key to the first unit. The first unit decrypts the received common key, encrypts a digital audio signal with the decrypted common key, and transmits the encrypted digital audio signal to the second unit. Thus, the digital audio data to be transmitted can be sufficiently protected from being illegally accessed or copied.

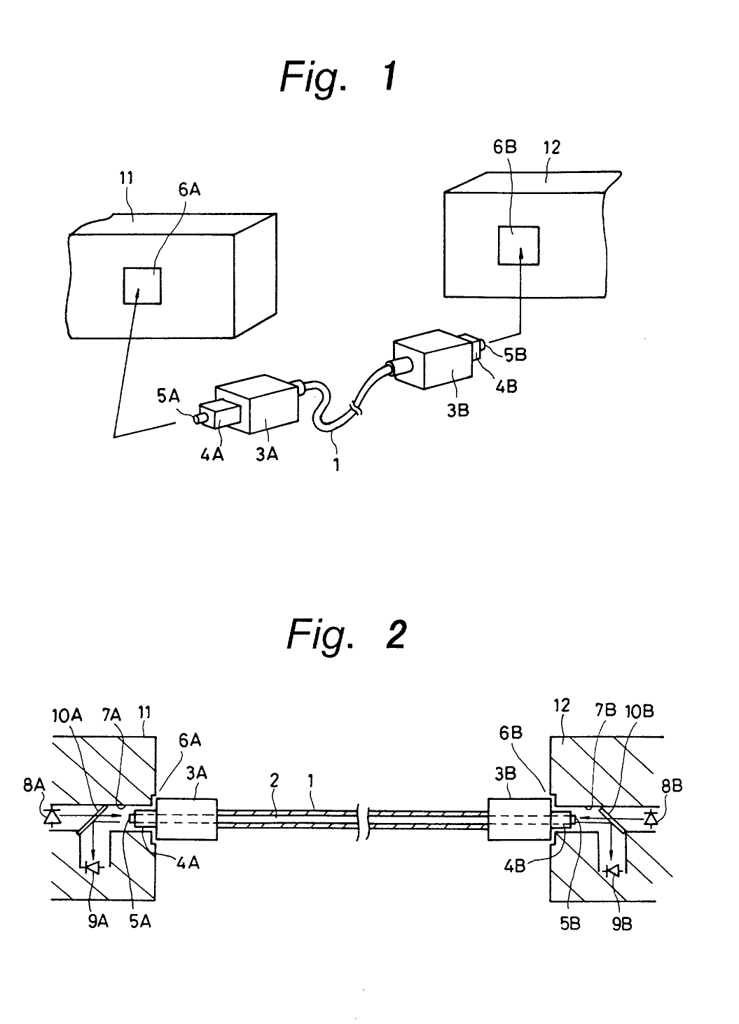

FIG. 1 shows an example of the structure of an interface that transmits digital audio data. In FIG. 1, reference numeral 1 is an optical cable. The optical cable 1 is an optical cable corresponding to the IEC 95 standard.

As shown in FIG. 2, optical fibers 2 are disposed at the center of the optical cable 1. Through the optical fibers 2, digital data is transmitted as an optical signal.

Plugs 3A and 3B are disposed on both ends of the optical cable 1, respectively. The plugs 3A and 3B have fitting portions 4A and 4B, respectively. The outer peripheries of the fitting portions 4A and 4B are squarely-shaped.

Light guiding portions 5A and 5B that transmit optical signals to the optical fibers 2 of the optical cable 1 are disposed at the center of the fitting portions 4A and 4B, respectively.

Reference numerals 6A and 6B are connectors. The connectors 6A and 6B are disposed on a host-side audio unit 11 that transmits a digital audio signal and another audio unit 12 that receives a digital audio signal, respectively. The connectors 6A and 6B have angular concave portions 7A and 7B that fit the fitting portions 4A and 4B, respectively.

As shown in FIG. 2, the connector 6A has a light emitting device 8A, a light receiving device 9A, a half mirror 10A. Likewise, the connector 6B has a light emitting device 8B, a light receiving device 9B, and a half mirror 10B.

As shown in FIG. 2, when the plug 3A of the optical cable 1 is connected to the connector 6A of the audio unit 11, the fitting portion 4A of the plug 3A is fitted to the concave portion 7A of the connector 6A. Likewise, when the plug 3B of the optical cable 1 is connected to the connector 6B of the audio unit 12, the fitting portion 4B of the plug 3B is fitted to the concave portion 7B of the connector 6B.

Data is bidirectionally communicated between the audio unit 11 and the audio unit 12 by a time division multiplexing method.

When data is transmitted from the audio unit 11 to the audio unit 12, an optical signal is transmitted from the light emitting device 8A of the connector 6A. This signal is input from the light guiding portion 5A of the plug 3A connected to the connector 6A through the half mirror 10A.

Thereafter, the optical signal is transmitted to the plug 3B through the optical fibers 2 of the optical cable 1. An output signal of the light guiding portion 5B of the plug 3B is reflected by the half mirror 10B of the connector 6B and received by the light receiving device 9B.

Thus, data is transmitted from the audio unit 11 to the audio unit 12.

When data is transmitted from the audio unit 12 to the audio unit 11, an optical signal is transmitted from the light emitting device 8B of the connector 6B.

The signal is input from the light guiding portion 5B of the plug 3B connected to the connector 6B through the half mirror 10B and sent to the plug 3A through the optical fibers 2 of the optical cable 1. An output signal of the light guiding portion 5A of the plug 3A is reflected by the half mirror 10A of the connector 6A. The reflected signal is received by the light receiving device 9A. Thus, data is transmitted from the audio unit 12 to the audio unit 11.

Since the light emitting devices 8A and 8B and the light receiving devices 9A and 9B are disposed on the connectors 6A and 6B sides, respectively, data can be bidirectionally transmitted with the optical cable 1 corresponding to the IEC 958 standard on time division basis.

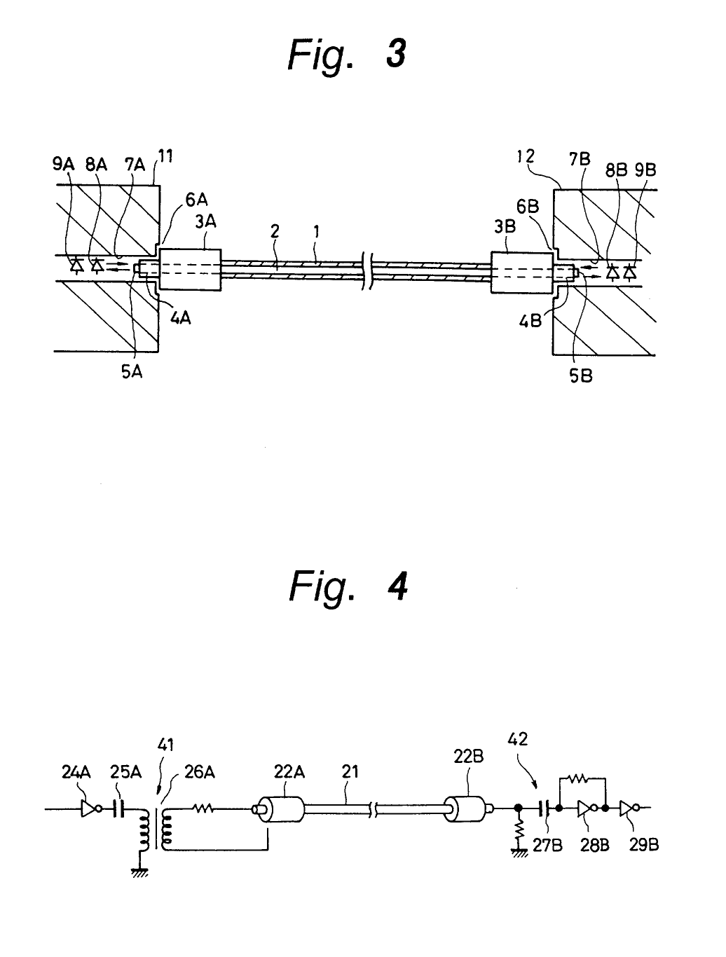

In the above-described example, the light emitting devices 8A and 8B, the light receiving devices 9A and 9B, and the half mirrors 10A and 10B are disposed on the connector sides 6A and 6B, respectively. Alternatively, as shown in FIG. 3, the light emitting devices 8A and 8B and the light receiving devices 9A and 9B may be adjacently disposed on the connector 6A and 6B sides, respectively.

In other words, as shown in FIG. 3, the light emitting devices 8A and 8B and the light receiving devices 9A and 9B are adjacently disposed, respectively. When data is transmitted from the audio unit 11 to the audio unit 12, an optical signal emitted from the light emitting device 8A of the connector 7A is input from the light guiding portion 5A of the plug 3A. Thereafter, the optical signal is sent to the plug 3B through the optical fibers 2 of the optical cable 1.

An output signal of the light guiding portion 5B of the plug 3B is received by the light receiving device 9B. Thus, data is transmitted from the audio unit 11 to the audio unit 12.

When data is transmitted from the audio unit 12 to the audio unit 11, an optical signal emitted by the light emitting device 8B of the connector 7B is input from the light guiding portion 5B of the plug 3B. Thereafter, the optical signal is sent to the plug 3A through the optical fibers 2 of the optical cable 1.

An output signal of the light guiding portion 5A of the plug 3A is received by the light receiving device 9A. Thus, data is transmitted from the audio unit 12 to the audio unit 11.

In the above-described example, the optical cable 1 is used. Alternatively, a coaxial cable may be used to transmit data.

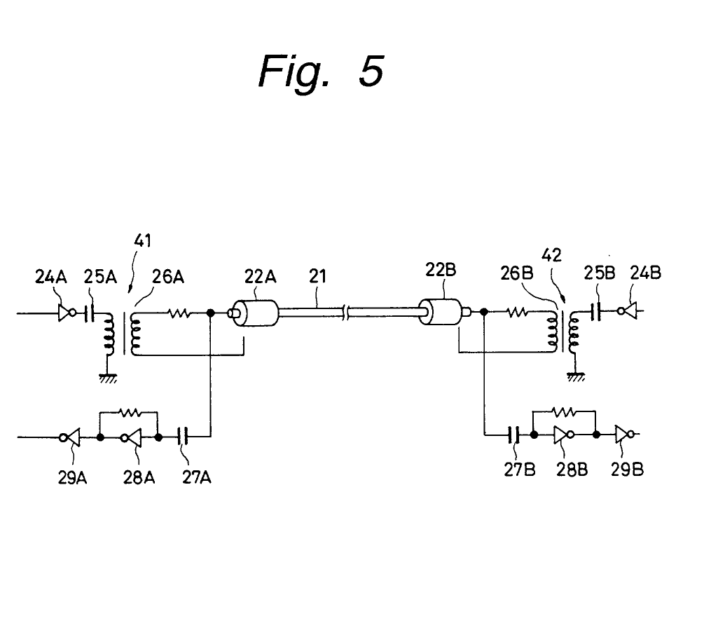

In other words, when data is transmitted with a coaxial cable corresponding to the IEC 958 standard, as shown in FIG. 4, plugs 22A and 22B are disposed on both sides of a coaxial cable 21. The impedance of the coaxial cable 21 is for example 75 ohms.

Output data of an audio unit 41 on the data transmitting side is sent to the plug 22A through a buffer 24A, a condenser 25A, and a transformer 26A.

Thereafter, the data is sent to the plug 22B of an audio unit 42 on the data receiving side through the coaxial cable 21. Output data of the plug 22B is sent through a condenser 27B and buffers 28B and 29B.

When data is bidirectionally transmitted with such a coaxial cable, as shown in FIG. 5, in the audio unit 41 on the transmitting side, data is transmitted through the buffer 24A, the condenser 25A, and the transformer 26A. In addition, data is received through a condenser 27A and buffers 28A and 29A.

In the audio unit 42 on the receiving side, data is received through a condenser 27B and buffers 28B and 29B. In addition, data is transmitted through a buffer 24A and condensers 25B and 26B.

Next, the structure for transmitting digital audio data with the above-described bidirectional interface will be described.

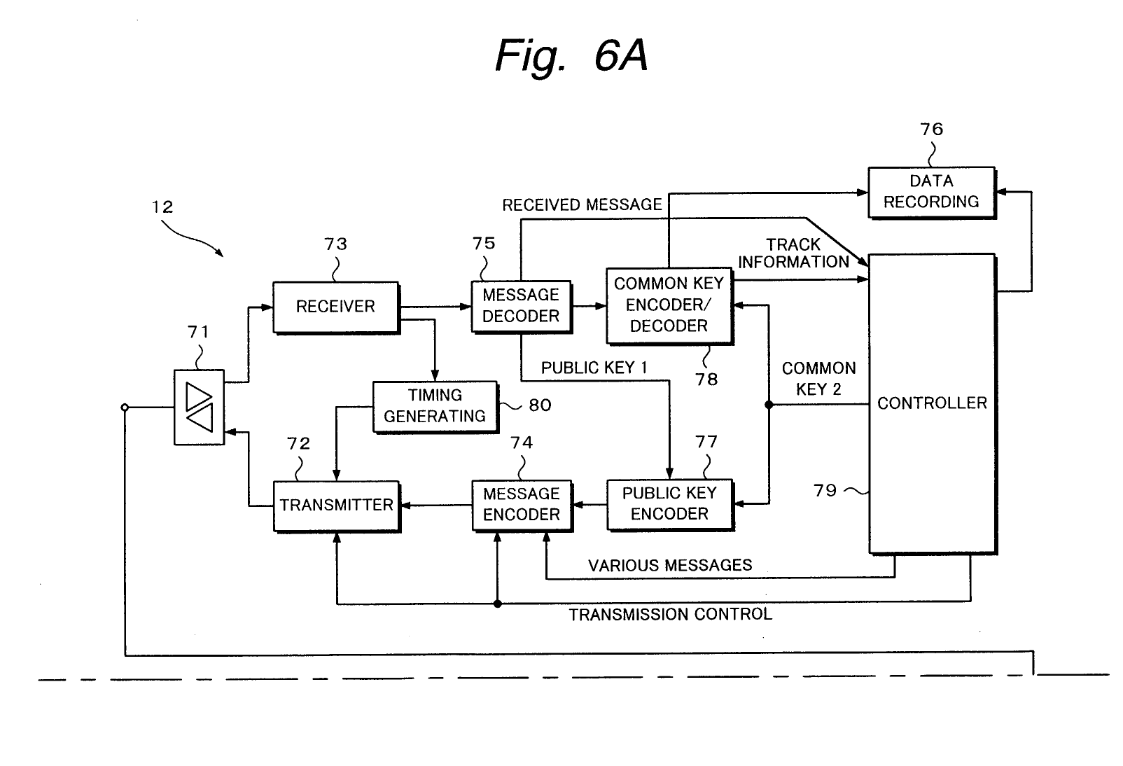

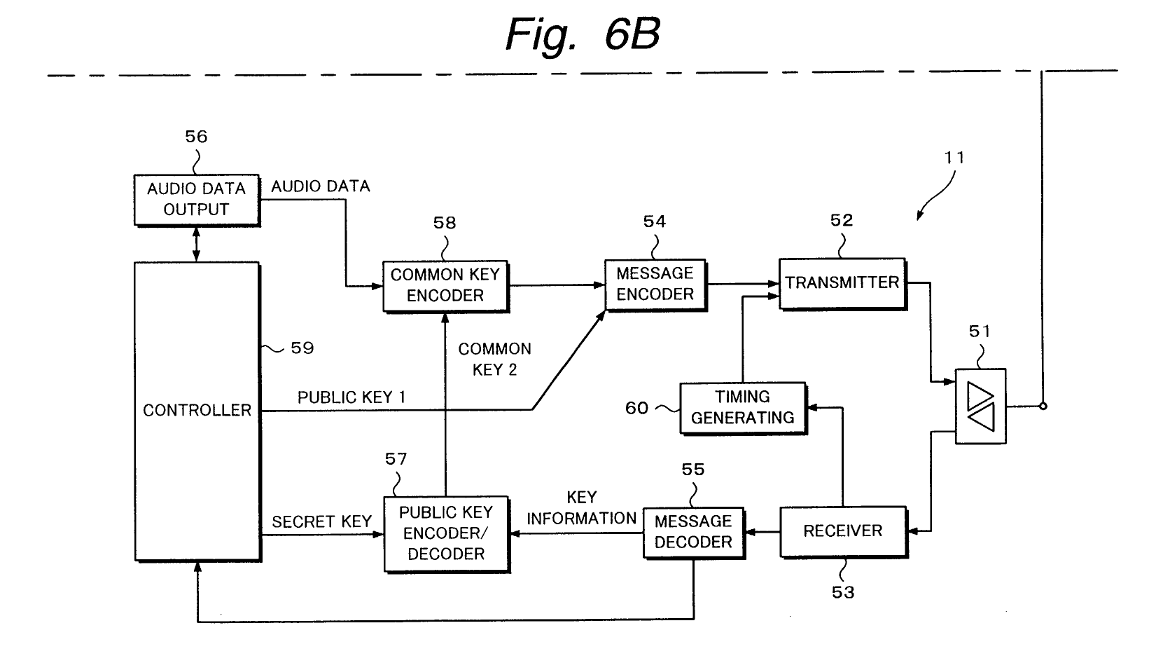

FIGS. 6A and 6B are block diagrams showing the structure of which a host-side audio unit 11 and an audio unit 12 that receives digital audio data therefrom are connected through a bidirectional interface corresponding to the IEC 958 standard.

In FIGS. 6A and 6B, the host-side digital audio unit 11 has an interface 51, a transmitter 52, and a receiver 53. The interface 51 allows an optical signal to be bidirectionally transmitted. The transmitter 52 transmits the optical signal to the interface 51. The receiver 53 receives data from the interface 51. The interface 51 is a bidirectional interface corresponding to the IEC 958 standard.

Transmission timing and reception timing of data are controlled by a timing generating circuit 60. Data to be transmitted has a predetermined format. A message is added to the data.

A message to be sent to the receiving side is encoded by a message encoder 54. Likewise, a message received from the transmitting side is decoded by a message decoder 55.

Digital audio data to be transmitted is sent from an audio data outputting circuit 56.

When digital audio data is transmitted from the audio unit 11 to the audio unit 12, the digital audio data is compressed by for example ATRAC (Adaptive Transform Acoustic Coding) method. In addition, to protect the digital audio data from being illegally accessed or copied, after the digital audio data is encoded, it is transmitted.

To perform such an encrypting process, the audio unit 11 has a public key encrypting/decrypting circuit 57 and a common key encrypting circuit 58. All processes of the audio unit 11 are controlled by a controller 59.

On the other hand, the digital audio unit 12 that receives digital audio data from the host-side digital audio unit 11 has an interface 71, a transmitter 72, and a receiver 73. The interface 71 performs a bidirectional data communication with an optical signal. The transmitter 72 transmits an optical signal to the interface 71. The receiver 73 receivers data from the interface 71. The interface 71 is a bidirectional interface corresponding to the IEC 958 standard.

Transmission timing and reception timing of data are controlled by a timing generating circuit 80. The data to be transmitted has a predetermined format. A message is added to the data.

A message to be transmitted to the host-side audio unit 11 is encoded by a message encoder 74. A message received from the host-side audio unit 11 is decoded by a message decoder 75.

Digital audio data received from the host-side digital audio unit 11 is decrypted and recorded on a record medium by a data recording circuit 76.

When digital audio data is transmitted from the audio unit 11 to the audio unit 12, the digital audio data is encrypted. To perform such an encrypting process, the audio unit 12 has a public key encrypting circuit 77 and a common key encrypting/decrypting circuit 78. All processes of the audio unit 12 are controlled by a controller 79.

Next, the operation of which the audio unit 11 and the audio unit 12 exchange a message and the operation of which the audio unit 11 transmits digital audio data to the audio unit 12 will be described.

When a message is transmitted from the audio unit 11 to the audio unit 12, the message encoder 54 of the audio unit 11 generates a message corresponding to a command received from the controller 59. This message is transmitted from the transmitter 52 through the interface 51. Thereafter, the message is transmitted to the interface 71 of the audio unit 12 on the receiving side through the optical cable 1.

Output data of the interface 71 is sent to the receiver 73. Output data of the receiver 73 is sent to the message decoder 75. The message decoder 75 decodes the message. Output data of the message decoder 75 is sent to the controller 79.

When the audio unit 12 sends back a message to the audio unit 11, the message encoder 74 of the audio unit 12 generates a message corresponding to a command received from the controller 79. This message is transmitted from the transmitter 72 through the interface 71. Thereafter, the message is transmitted to the interface 51 of the audio unit 12 through the optical cable 1.

Output data of the interface 51 is sent to the receiver 53. Output data of the receiver 53 is sent to the message decoder 55. The message decoder 55 decodes the message. Output data of the message decoder 55 is sent to the controller 59.

When the audio unit 11 transmits digital audio data to the audio unit 12, the audio data outputting portion 56 outputs digital audio data that has been compressed by for example ATRAC method. The digital audio data is sent to the encrypting circuit 58. Thereafter, the digital audio data is encrypted with a common key Key2 received from the public key encrypting/decrypting circuit 57.

The encrypted audio data is sent to the message encoder 54. The message encoder 54 arranges the encrypted audio data in a predetermined format. At this point, a message can be added to the digital audio data. The resultant digital audio data is transmitted from the transmitter 52 through the interface 51. Thereafter, the digital audio data is transmitted to the interface 71 of the audio unit 12 on the receiving side through the optical cable 1.

Output data of the interface 71 is sent to the receiver 73. Output data of the receiver 73 is sent to the message decoder 75. The message decoder 75 decodes the message.

Output data of the message decoder 75 is sent to the common key encrypting/decrypting circuit 78. A common key Key 2 is sent from the controller 79 to the common key encrypting/decrypting circuit 78. The common key encrypting/decrypting circuit 78 decrypts the encrypted digital audio data with the common key Key2. Output data of the common key encrypting/decrypting circuit 78 is sent to the recoding/reproducing circuit 76.

When digital audio data is transmitted from the audio unit 11 to the audio unit 12, the digital audio data is encrypted. Thus, the digital audio data can be protected from illegally accessed or copied.

When such an encrypting process is performed, such an encryption key is transmitted in the following manner.

A public key Key 1 is sent from the audio unit 11 to the audio unit 12 through the message encoder circuit 54, the transmitter circuit 52, and the interface 51.

The public key encrypting circuit 77 of the audio unit 12 encrypts the common key Key 2 with the public key Key 1.

The common key Key 2 encrypted by the public key Key 1 is transmitted from the audio unit 12 to the audio unit 11 through the message encoder circuit 74, the transmitter circuit 72, and the interface 71.

The public key encrypting/decrypting circuit 57 of the audio unit 11 decrypts the common key Key 2 with the public key Key 1 received from the audio unit 12 and a secret key received from the controller 59.

The audio unit 11 encrypts digital audio data with the common key Key 2.

The controller 59 of the audio unit 11 generates the public key Key 1. The public key Key 1 is sent to the message encoder 54. The message encoder 54 arranges the public key Key 1 in a predetermined format. The encryption key Key 1 is transmitted from the transmitter 52 through the interface 51. Thereafter, the encryption key Key 1 is sent to the interface 71 of the audio unit 12 on the receiving side through the optical cable 1.

Output data of the interface 71 is sent to the receiver 73. Output data of the receiver 73 is sent to the message decoder 75. The message decoder 75 sends the public key Key 1 to the public key encrypting circuit 77.

The controller 79 generates the common key Key 2. The common key Key 2 is sent to the public key encrypting circuit 77. The public key encrypting circuit 77 encrypts the common key Key 2 with the public key Key 1. The common key Key 2 encrypted with the public key Key 1 is sent to the message encoder 74.

The message encoder 74 arranges the common key Key 2 encrypted with the public key Key 1 in a predetermined format. The common key Key 2 encrypted with the public key Key 1 is transmitted from the transmitter 72 through the interface 71. Thereafter, the common key Key 2 is transmitted to the interface 51 of the audio unit 11 through the optical cable 1.

Output data of the interface 51 is sent to the receiver 53. Output data of the receiver 53 is sent to the message decoder 55. The message decoder 55 decrypts the common key Key 2 encrypted with the public key Key 1. Output data of the message decoder 55 is sent to the public key decrypting circuit 57. The public key decrypting circuit 57 decrypts the common key Key 2 with the public key Key 1 and the secret key received from the controller 59.

When digital audio data is transmitted from the audio unit 11 to the audio unit 12, the common key Key 2 is sent to the common key encrypting circuit 58. The common key encrypting circuit 58 encrypts digital audio data received from the audio data outputting circuit 56 with the common key Key 2.

Next, a data transmission format of data exchanged between the audio unit 11 and the audio unit 12 and a data transmission format of digital audio data transmitted from the audio unit 11 to the audio unit will be described.

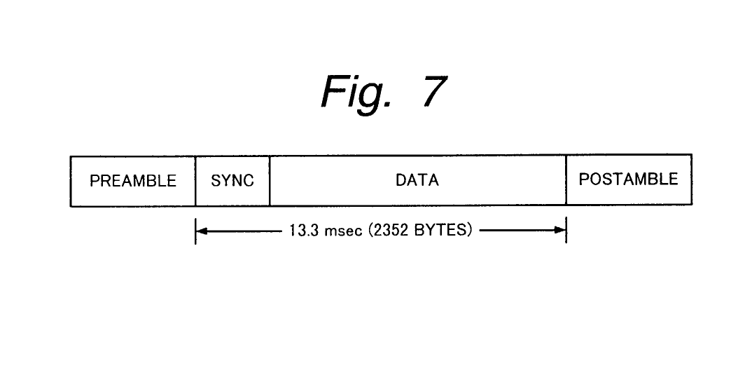

As shown in FIG. 7, as with the format of a CD-ROM, data for 13.3 msec is transmitted at a time. In other words, in a CD-ROM, one sector is composed of 98 frames. One frame contains 24 bytes of data. Thus, one sector is (24×98=2352 bytes). The time period of one sector is 13.3 msec. As with one sector of a CD-ROM, data for 13.3 msec is transmitted at a time.

One sector is composed of a synchronous signal portion (sync) and a data portion. The synchronous signal portion and the data portion are surrounded by a preamble portion and a postamble portion.

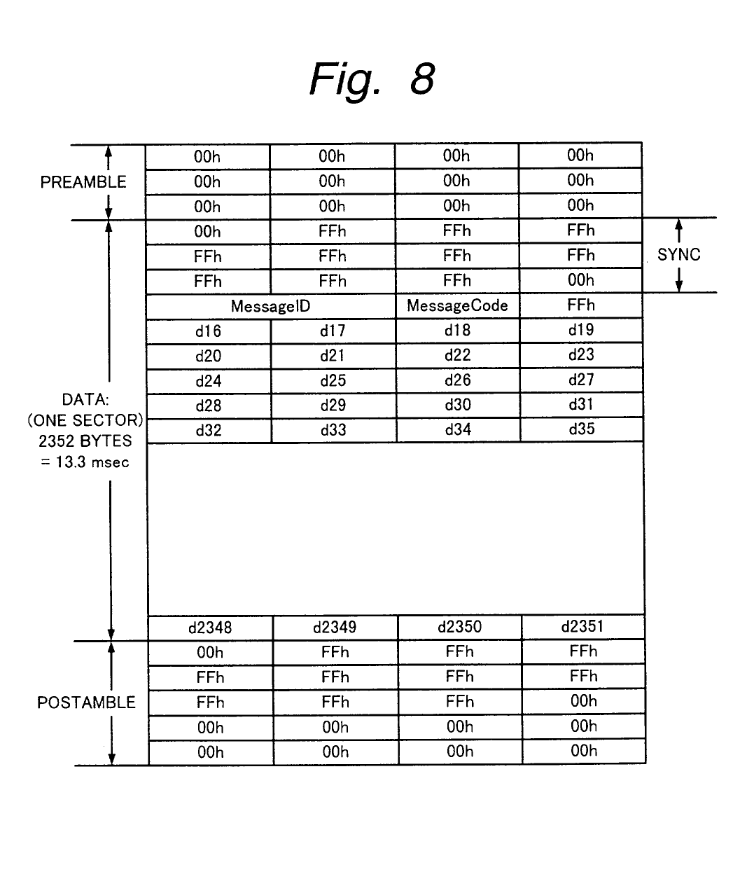

Data exchanged between the audio unit 11 and the audio unit 12 is transmitted in a format shown in FIG. 8.

In FIG. 8, at the beginning of each sector (2352 bytes =13.3 msec), a preamble with a predetermined pattern is disposed. At the end of each sector, a postamble with a predetermined pattern is disposed. A data area for one sector (2352 bytes) is disposed between the preamble and the postamble. The data area is composed of 2352 bytes that are denoted by d0, d1, d2, . . . , and d2351.

A sync with a predetermined pattern is disposed from d0 to d11 bytes at the beginning of the data area. In this sync, the first byte, d0, is “00h” (where h represents hexadecimal notation). d1 to d10 bytes are “FFh”. The last byte, d11, is “00h”.

d12 and d13 bytes are a message ID for identifying a message. d14 byte is a message code.

d15 byte is “FFh”. d16 to d2351 bytes are data.

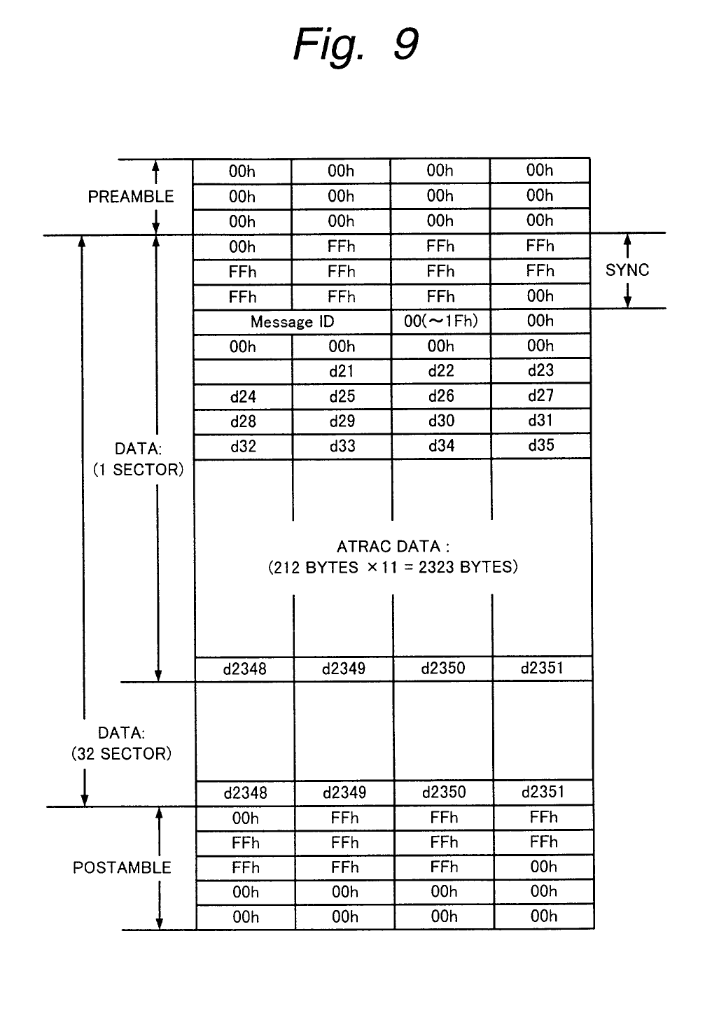

Digital audio data is transmitted as clusters (one cluster is composed of 32 sectors) from the audio unit 11 to the audio 12 as shown in FIG. 9. At the beginning of each cluster, a preamble with a predetermined pattern is disposed. At the end of each cluster, a postamble with a predetermined pattern is disposed.

At the beginning of the data area of each sector, a sync with a predetermined pattern is disposed. In this sync, the first byte, d0, is “00h”. d1 to d10 mbytes are “FFh”. The last byte, d0, is “00h”.

d12 to d13 bytes are a message ID. d14 byte is a cluster number. Each cluster has a unique cluster number successively incremented.

d15 byte is “FFh”. d16 to d2351 bytes are digital audio data compressed by ATRAC method. Thus, digital audio data compressed by ATRAC method as 2332 bytes per sector is transmitted.

Next, a message exchanged between the audio unit 11 and the audio unit 12 will be described.

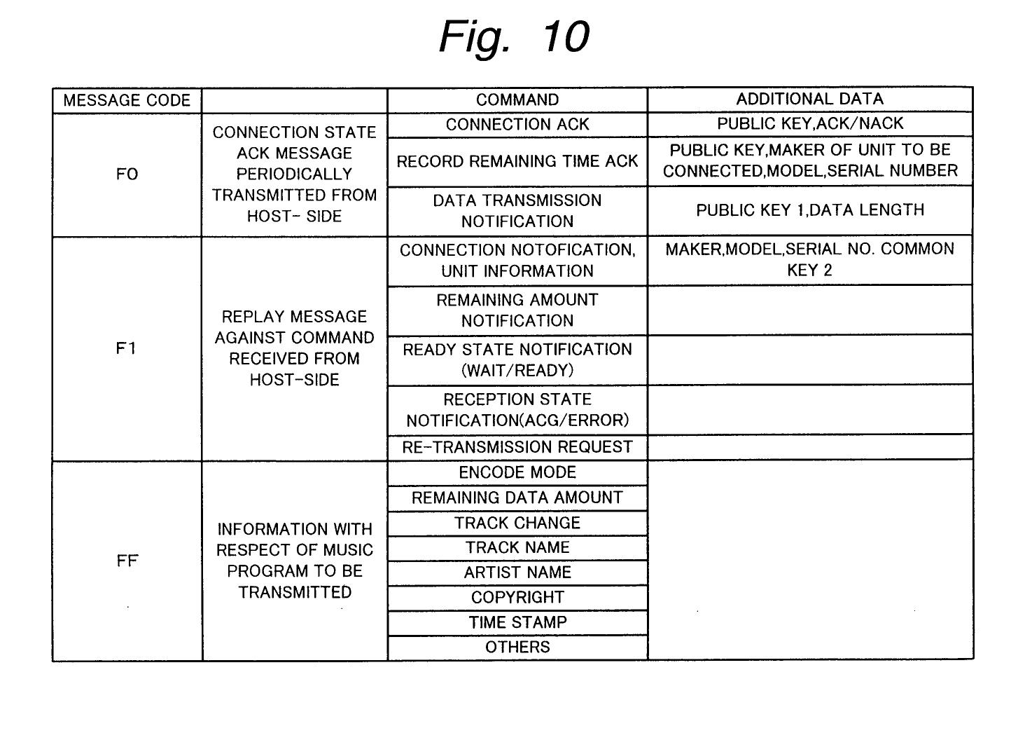

As shown in FIG. 8, a message code is disposed at d14 byte. FIG. 10 shows message codes exchanged between the audio unit 11 and the audio unit 12. FIG. 11 shows additional data disposed in one sector.

As shown in FIG. 10, the message codes are categorized as an acknowledgment message F10, a reply message F1, an information message FF. The acknowledgment message F0 is periodically transmitted from the transmitting side. The reply message F1 is a reply message against a message received from the transmitting side. The information message FF represents information with respect to digital audio data transmitted.

As shown in FIG. 10, the acknowledgment message F0 includes a connection acknowledgment command, a record remaining time acknowledgment command, and a data transmission notification command.

With respect to the connection acknowledgment command, non-acknowledgment/acknowledgment data and the public key Key 1 are added as additional data. As shown in FIG. 11, the non-acknowledgment/acknowledgment data is disposed at d29 byte. The public key Key 1 is disposed from d30 to d34 bytes.

With respect to the record remaining time acknowledgment command, a public key Key 1, a maker code of a unit to be connected, a model code, and a serial number are added as additional data. As shown in FIG. 11, the maker code is disposed at d43 byte. The model code is disposed at d44 byte. The serial number is disposed from d45 to d47 bytes. Data encrypted with the common key is disposed after d41 byte.

The reply message F1 includes a connection notification and unit information command, a remaining time notification command, a ready state notification command, a reception state notification command, and a re-transmission request command.

With respect to the connection notification and unit information command, a maker code, a model code, a serial number, and a common key Key 2 are added as additional data.

As shown in FIG. 11, the maker code is disposed at d43 byte. The model code is disposed at d44 byte. The serial number is disposed from d45 to d47 bytes. The common key Key 2 is disposed from d48 to d52 bytes. Data encrypted with the common key is disposed after d41 byte.

The information message FF with respect to audio data includes an encode mode, a remaining data amount, a track change, a track name, an artist name, a copyright, a time stamp, and so forth.

As shown in FIG. 11, the data length is disposed at d29 byte. The encode mode is disposed from d30 to d31 bytes. The track change is disposed at d32 byte. The copyright is disposed at d33 byte. The year of the time stamp is disposed at d34 byte. The month of the time stamp is disposed at d35 byte. The day of the time stamp is disposed at d36 byte. The hour of the time stamp is disposed at d37 byte. The second of the time stamp is disposed at d38 byte. The track name is disposed at d43 byte. The artist name is disposed at d44 byte.

Data is exchanged between the audio unit 11 and the audio unit 12 in the above-described data transmission format.

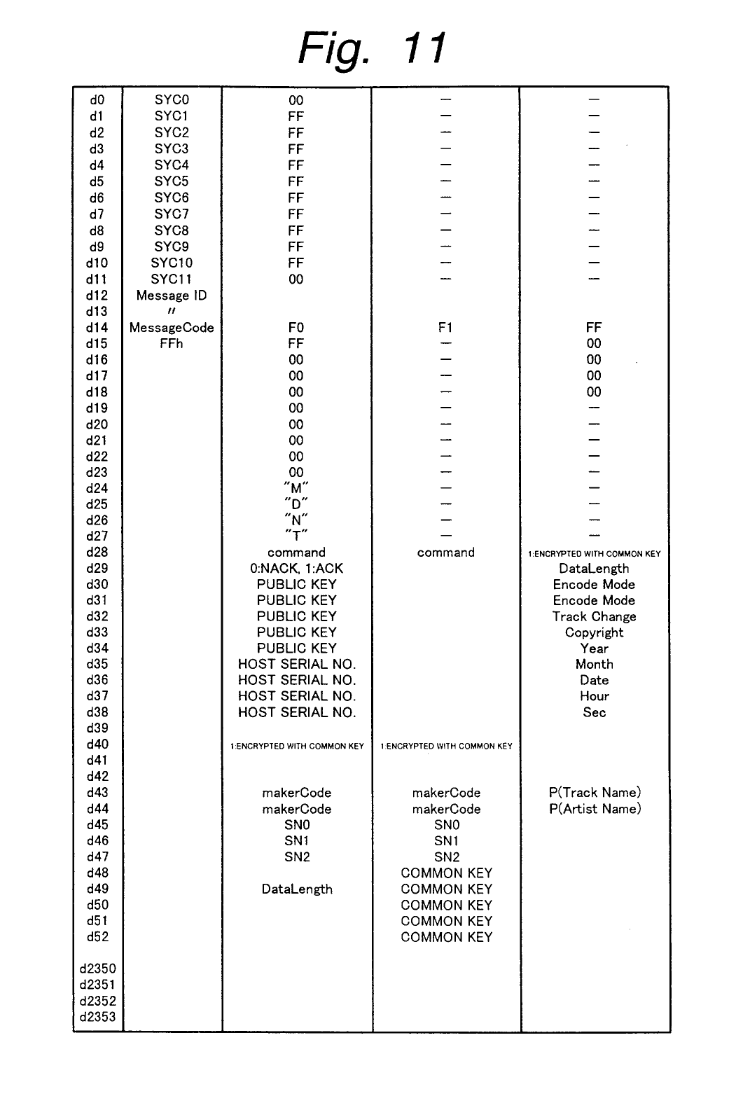

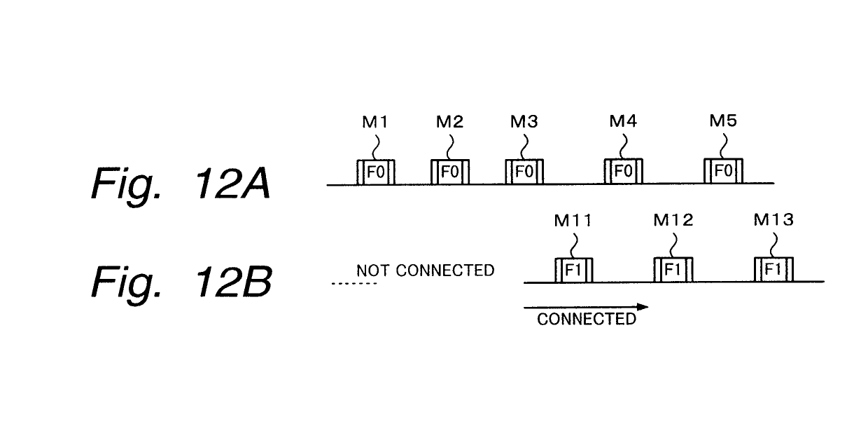

FIGS. 12A and 12B are timing charts showing a connection acknowledging process for determining whether the audio unit 12 has been connected to the audio unit 11. FIG. 12A shows data transmitted from the audio unit 11 to the audio unit 12. FIG. 12B shows data transmitted from the audio unit 12 to the audio unit 11. As described above data is formatted every 13.3 msec as with the CD-ROM format.

As shown in FIG. 12A, the audio unit 11 periodically transmits the connection acknowledgment command (M1, M2, . . . ) from the audio unit 11 to the audio unit 12. As described above, the connection acknowledgment command is included in the acknowledgment message F0.

When the audio unit 12 has not been connected to the audio unit 11, a connection notification is not sent back against the connection acknowledgment command (M1, M2, . . . ).

When the audio unit 12 has been connected to the audio unit 11, as shown in FIG. 12B, a connection notification and unit information command (M1, M12, . . . ) is sent back against the connection acknowledgment command (M1, M2, . . . ). The connection notification and unit information command is included in the reply message F1.

With the connection acknowledgment and unit information command (M1, M12, . . . ), the audio unit 11 can determine that another audio unit has been connected thereto. With additional data added to the connection notification and unit information command (namely, the maker code, the model code, the serial number, and the common key Key 2), the audio unit 11 can obtain information with respect to the audio unit connected thereto.

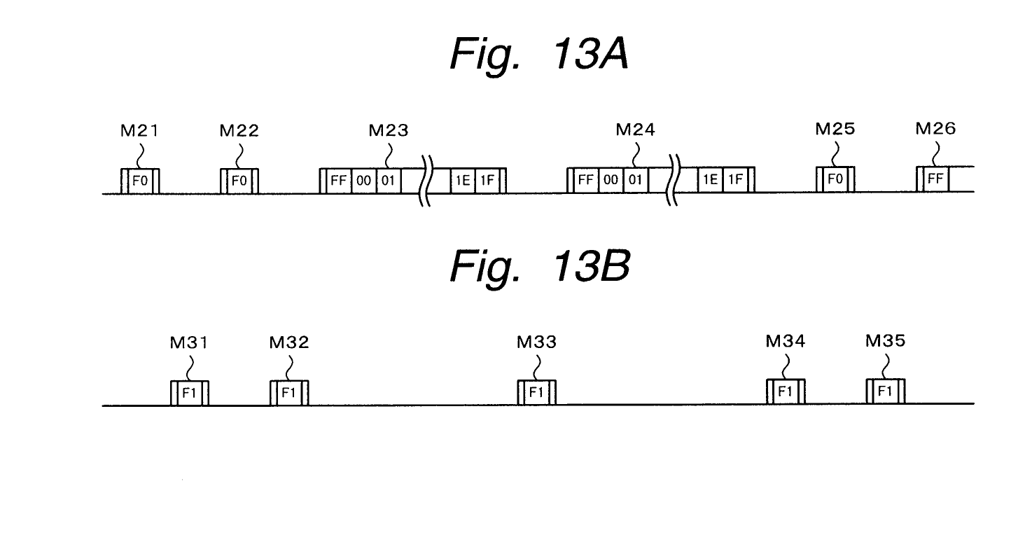

FIGS. 13A and 13B are timing charts showing a process for transmitting digital audio data from the audio unit 11 to the audio unit 12. FIG. 13A shows data transmitted from the audio unit 11 to the audio unit 12. FIG. 13B shows data transmitted from the audio unit 12 to the audio unit 11.

As shown in FIG. 13A, when digital audio data is transmitted from the audio unit 11 to the audio unit 12, the data transmission notification command (M21) is transmitted from the audio unit side 11 to the audio unit 12. The data transmission notification command is included in the acknowledgment message F0.

When the audio unit 12 is not ready to receive digital audio data, the audio unit 12 sends back the ready state notification (M31) that represents a wait request to the audio unit 11. The ready state notification is included in the reply message F1.

When the audio unit 11 has received the ready state notification (M31) (which represents a wait request), the audio unit 11 enters into a waiting mode for a predetermined time period. After the predetermined time period has elapsed, the audio unit 11 transmits the data transmission notification command (M22) to the audio unit 12.

When the audio unit 12 is ready to receive digital audio data, the audio unit 12 sends back the ready state notification command (M32) (that represents the ready state of the audio unit 12) to the audio unit 11.

When the audio unit 11 has received the ready state notification command (M32) (which represents the ready state of the audio unit 12), the audio unit 11 transmits digital audio data for one cluster (32 sectors) at a time to the audio unit 12. The digital audio data includes information such as a data length, an encode mode, a track name, an artist name, a copyright, and a time stamp (M23).

When the audio unit 12 has received data for one cluster, the audio unit 12 transmits the reception state notification command (M33) to the audio unit 11. The reception state command is included in the replay message F1. When the audio unit 12 has correctly received the digital audio data, the reception state notification command (M33) placed in an acknowledged state. Otherwise, the reception state notification command (M33) is placed in an error state.

The audio unit 12 determines whether or not the command sent back from the audio unit 11 has been placed in the acknowledged state or the error state. When the command has been placed in the acknowledged state, the audio unit 11 transmits digital audio data for the next cluster to the audio unit 12 (M24).

When the audio unit 12 has received data for one cluster, the audio unit 12 transmits the reception state notification command (M34) to the audio unit 11. When the audio unit 12 has not correctly received the digital audio data, the reception state notification command (M34) is placed in the error state (M34).

When the command sent back from the audio unit 11 has been placed in the error state, after a predetermined time period has elapsed, the audio unit 12 transmits the data transmission notification command (M25) to the audio unit 11.

When the audio unit 12 is ready to receive digital audio data, the audio unit 12 sends back the ready state notification command (which represents the ready state of the audio unit 12) to the audio unit 11.

When the audio unit 11 has received the ready state notification command (M35) (which represents the ready state), the audio unit 11 transmits digital audio data for one cluster (32 sectors) to the audio unit 12 (M26).

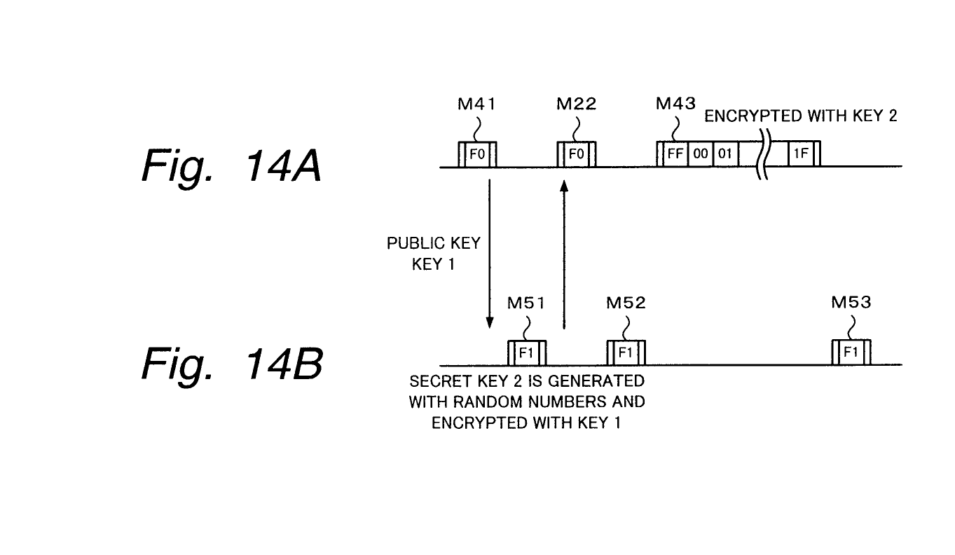

FIGS. 14A and 14B are timing charts showing an encrypting process for encrypting digital audio data transmitted from the audio unit 11 to the audio unit 12. FIG. 14A shows data transmitted from the audio unit 11 to the audio unit 12. FIG. 14B is data transmitted from the audio unit 12 to the audio unit 11.

As shown in FIGS. 14A and 14B, to acknowledge a connection between the audio unit 11 and the audio unit 12, the audio unit 11 transmits the connection acknowledgment command (M41) to the audio unit 12. The public key Key 1 is added to the connection acknowledgment command (M41). Thus, the public key Key 1 is transmitted from the audio unit 11 to the audio unit 12.

When the audio unit 12 has been connected to the audio unit 11, the audio unit 11 sends back the connection notification and unit information command (M51) against the connection acknowledgment command (M41) to the audio unit 12. The public key Key 1 and the common key Key 2 are added to the connection notification and unit information command (M51). Thus, the common key Key 2 is transmitted from the audio unit 12 to the audio unit 11.

When digital audio data is transmitted from the audio unit 11 to the audio unit 12, the data transmission notification command (M42) is transmitted from the audio unit 11 to the digital audio unit 12.

When the audio unit 12 is ready to receive digital audio data, the audio unit 12 sends back the ready state notification command (M52) (which represents the ready state of the audio unit 12) to the audio unit 11.

When the audio unit 11 has received the ready state notification (M52) (which represents the ready state of the audio unit 12), the audio unit 11 transmits digital audio data for one cluster (32 sectors) at a time to the audio unit 12. The digital audio data has been encrypted with the common key Key 2.

When the audio unit 12 has received data for one cluster, the audio unit 12 transmits the reception state notification command (M53) to the audio unit 11.

As described above, in the interface according to the present invention, with a cable and a connector corresponding to the IEC 958 standard, data can be bidirectionally communicated on time division basis. Since data is bidirectionally transmitted, an encrypting process can be performed as follows. A first audio unit transmits a public key Key 1 to a second audio unit. The second audio unit sends back a common key Key 2 encrypted with the public key Key 1 to the first audio unit. The first audio unit encrypts digital audio data with the common key Key 2 and transmits the encrypted digital audio data to the second audio unit. Thus, with a conventional cable and a connector corresponding to the IEC 958 standard, digital audio data can be protected from being illegally accessed or copied.

The present invention is suitable for a system that circulates a digital audio signal especially through an ISDN circuit and/or a communication satellite.

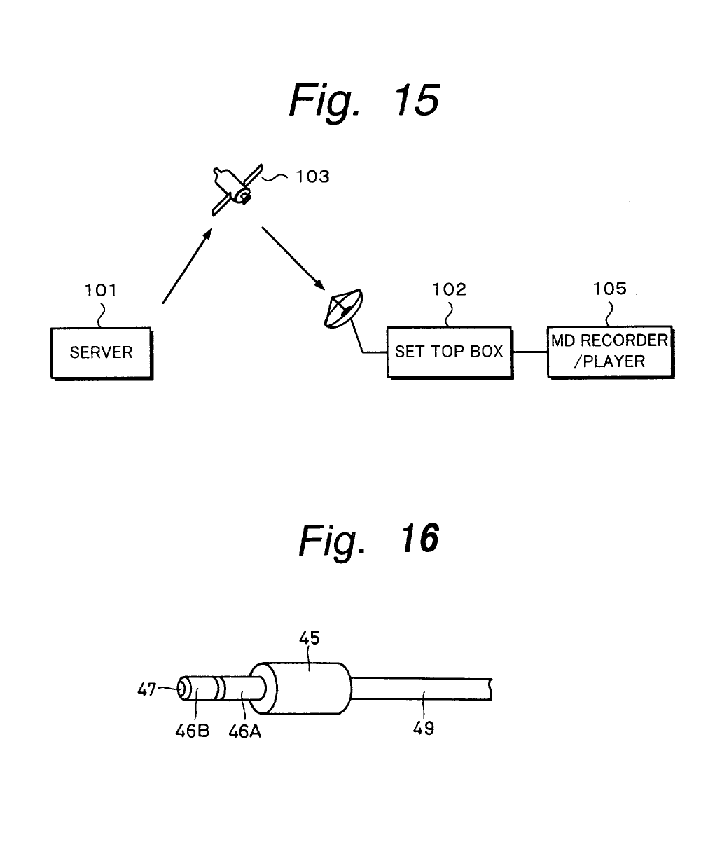

In such a service, as shown in FIG. 15, a server 101 that performs a music program circulating service is disposed on a communication network. A user-side set top box 102 and the server 101 are connected through for example a satellite circuit 103. By operating the user-side set top box 102, desired music data is circulated from the server 101 through the satellite circuit 103. The music data is recorded on a mini-disc by an MD recorder/player 105.

When the user downloads desired music data from the server 101 with the set top box 102, a proper charging process is performed. In addition, to easily retrieve music data from the server 101, a retrieving system is provided. Moreover, the server 101 provides the user with various information with respect to music such as hit program information and new music score information.

When the user retrieves his/her favorite music data from the server, downloads it therefrom, and records it on a mini-disc or the like with such a service, he or she can purchase music data on the network. However, in such a system, it should be noted that problems on copyright tend to take place.

When the present invention is applied for such a system, the master-side audio unit 11 corresponds to the set top box. The audio unit 12, which receives digital audio data from the master-side audio unit 11, corresponds to the mini-disc recorder/player.

In the above-described example, a cable and a connector corresponding to the IEC 958 standard are used. Data is bidirectionally communicated on time division basis. Alternatively, a feeder and a plug as shown in FIG. 16 may be used.

In FIG. 16, a terminal extrudes from a plug 45. The terminal has conductive sleeves 46A and 46B. The conductive sleeve 46A inputs/outputs an audio signal on the right channel. The conductive sleeve 46B inputs/outputs an audio signal on the left channel. The feeder 49 has conductive cables and optical fibers. The conductive cables transmit audio signals on the left and right channels. The optical fibers transmit optical signals. A light guiding portion 47 is disposed at the center of the terminal. With such a plug, digital signals are transmitted with the optical fibers. Data is transmitted with the conductive cables for the left and right channels. Thus, data can be bidirectionally communicated.

According to the present invention, with a cable and a connector corresponding to the IEC 958 standard, data can be bidirectionally communicated on time division basis. Data to be transmitted is formatted for 2352 bytes (13.3 msec) as with each sector of the CD-ROM format or MD format. This data format has a message code area. When digital audio data is transmitted, with a message code, a public key is transmitted from a transmitting unit to a receiving unit. The receiving unit sends back a common key encrypted with the public key to the transmitting unit. The transmitting unit decrypts the common key. The transmitting unit encrypts digital audio data with the common key. Thus, with a conventional cable and a conventional connector, digital audio data can be prevented from being illegally accessed or copied.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A data transmitting apparatus having a first digital unit and a second digital unit, a connector of the first digital unit and a connector of the second digital unit being connected with a cable,
wherein the first digital unit has:
bidirectional interface means for transmitting/receiving data through the cable;
encoding means for encoding a message transmitted from the first digital unit to the second digital unit into a predetermined data sequence;
decoding means for decoding a data sequence received through said bidirectional interface means into a message transmitted from the second digital unit to the first digital unit; and
encrypting means for encrypting a digital signal transmitted from the first digital unit to the second digital unit,
wherein the second digital unit has:
bidirectional interface means for transmitting/receiving data through the cable;
encoding means for encoding a message transmitted from the second digital unit to the first digital unit into a predetermined data sequence;
decoding means for decoding a data sequence received through said bidirectional interface means into a message transmitted from the first digital unit to the second digital unit; and
decrypting means for decrypting an encrypted digital signal received from the first digital unit, and
wherein when a digital signal is transmitted from the first digital unit to the second digital unit, a message including encryption information is bidirectionally exchanged between the first digital unit and the second digital unit.

2. The data transmitting apparatus as set forth in claim 1,
wherein a message including encryption information is exchanged between the first digital unit and the second digital unit in such a manner that the first digital unit transmits a public key to the second digital unit, the second digital unit transmits a common key encrypted with the public key to the first digital unit, the first digital unit decrypts the common key encrypted with the public key and encrypts the digital signal with the common key.

3. The data transmitting apparatus as set forth in claim 1,
wherein the predetermined data sequence corresponds to one sector of CD-ROM format.

4. A data transmitting method of a first digital unit and a second digital unit, a connector of the first digital unit and a connector of the second digital unit being connected with a cable, comprising the steps of:
(a) encoding a message transmitted from the first digital unit to the second digital unit into a predetermined data sequence;
(b) decoding a received data sequence into a message transmitted from the second digital unit to the first digital unit;
(c) encrypting a digital signal transmitted from the first digital unit to the second digital unit;
(d) encoding a message transmitted from the second digital unit to the first digital unit into a predetermined data sequence;
(e) decoding the received data sequence into a message transmitted from the first digital unit to the second digital unit; and
(f) decrypting an encrypted digital signal received from the first digital unit,
wherein the steps (a) to (c) are performed by the first digital unit and the step (d) to (f) are performed by the second digital unit, and
wherein when a digital signal is transmitted from the first digital unit to the second digital unit, a message including encryption information is bidirectionally exchanged between the first digital unit and the second digital unit.

5. The data transmitting method as set forth in claim 4,
wherein a message including encryption information is exchanged between the first digital unit and the second digital unit in such a manner that the first digital unit transmits a public key to the second digital unit, the second digital unit transmits a common key encrypted with the public key to the first digital unit, the first digital unit decrypts the common key encrypted with the public key and encrypts the digital signal with the common key.

6. The data transmitting method as set forth in claim 4,
wherein the predetermined data sequence corresponds to one sector of CD-ROM format.
